(19) United States
(12) Patent Application Publication
(10) Pub. No.: US 2024/0054749 A1
(43) Pub. Date: Feb. 15, 2024

(54) INFORMATION PROCESSING DEVICE AND INFORMATION PROCESSING METHOD

(71) Applicant: SONY INTERACTIVE ENTERTAINMENT INC., Tokyo (JP)

(72) Inventors: Tatsuo Tsuchie, Tokyo (JP); DAISUKE TSURU, Chiba (JP); Hirofumi Okamoto, Tokyo (JP)

(21) Appl. No.: 18/361,931

(22) Filed: Jul. 31, 2023

(30) Foreign Application Priority Data
Aug. 9, 2022 (JP) 2022-127152

(51) Int. Cl. G06V 10/25; G06T 7/70; G06F 3/01; G02B 27/01

(52) U.S. Cl. CPC G06V 10/25; G06T 7/70; G06F 3/012; G02B 27/0172; G06V 2201/07; G06T 2207/20132

(57) ABSTRACT

Provided is an information processing device including a captured image acquisition section that acquires data of frames of a currently captured moving image, a crop section that cuts out an image of a specific region from each of the frames arranged in chronological order, and an image analysis section that analyzes the image of the specific region to acquire predetermined information. The crop section moves a cut-out target region in accordance with predetermined rules with respect to a time axis.

### CROSS REFERENCE TO RELATED APPLICATION

This application claims the benefit of Japanese Priority Patent Application JP 2022-127152 filed Aug. 9, 2022, the entire contents of which are incorporated herein by reference.

### BACKGROUND

The present disclosure relates to an information processing device and an information processing method that acquire state information regarding the real world by using a captured image.

Widely used is an image display system that enables a user wearing a head-mounted display to view a target space from a free viewpoint. There is known, for example, electronic content that implements virtual reality (VR) by using a three-dimensional virtual space as a display target and causing the head-mounted display to display an image based on the gaze direction of the user. By using the head-mounted display, it is also possible to enhance the sense of immersion in videos and improve the usability of games and other applications. Additionally developed is a walk-through system that allows the user wearing the head-mounted display to physically move to virtually walk around in a space displayed as a video.

### SUMMARY

In order to provide a high-quality user experience with use of the above-described technology, it may be required to accurately and constantly identify the state of real objects such as the location and the posture of the user and the positional relation of the user to furniture and walls around the user. Meanwhile, the number of sensors and other necessary equipment increase when an attempt is made to increase the amount of information to be acquired and improve the accuracy of information. This causes problems in terms, for example, of manufacturing cost, weight, and power consumption. Therefore, the state of real objects may be acquired by analyzing a captured image, which can be used for display purposes. However, particularly in an environment where the field of view of the captured image irregularly changes, there is a problem where information acquisition efficiency is low because necessary images are difficult to obtain.

The present disclosure has been made in view of the above circumstances, and it is desirable to provide a technology capable of efficiently acquiring the information regarding the real world through the use of a captured image.

In order to solve the above problems, a mode of the present disclosure relates to an information processing device. The information processing device includes a captured image acquisition section that acquires data of frames of a currently captured moving image, a crop section that cuts out an image of a specific region from each of the frames arranged in chronological order, and an image analysis section that analyzes the image of the specific region to acquire predetermined information. The crop section moves a cut-out target region in accordance with predetermined rules with respect to a time axis.

Another mode of the present disclosure relates to an information processing method. The information processing method includes acquiring data of frames of a currently captured moving image, cutting out an image of a specific region from each of the frames arranged in chronological order, and analyzing the image of the specific region to acquire predetermined information. The cutting out moves a cut-out target region in accordance with predetermined rules with respect to a time axis.

Any combinations of the above-mentioned component elements and any conversions of expressions of the present disclosure between, for example, systems, computer programs, recording media recording readable computer programs, and data structures are also effective as the modes of the present disclosure.

The present disclosure makes it possible to efficiently acquire information regarding the real world with use of a captured image.

### BRIEF DESCRIPTION OF THE DRAWINGS

FIG. 1 is a diagram illustrating an example of the appearance of a head-mounted display according to a preferred embodiment of the present disclosure;

FIG. 2 is a diagram illustrating an example configuration of an image display system according to the preferred embodiment;

FIG. 3 is a diagram illustrating an example of an image world that is displayed on the head-mounted display by an image generation device according to the preferred embodiment;

FIG. 4 is a diagram outlining the principle of visual simultaneous localization and mapping (SLAM);

FIG. 5 is a diagram illustrating an internal circuit configuration of the image generation device according to the preferred embodiment;

FIG. 6 is a diagram illustrating an internal circuit configuration of the head-mounted display according to the preferred embodiment;

FIG. 7 is a block diagram illustrating functional blocks of the image generation device according to the preferred embodiment;

FIG. 8 is a flowchart illustrating a processing procedure for allowing a play area control section according to the preferred embodiment to set a play area;

FIG. 9 is a diagram illustrating an example of a play area edit screen that is displayed in step S20 of FIG. 8;

FIG. 10 is a diagram illustrating a basic process that is performed by a crop section according to the preferred embodiment;

FIG. 11 is a diagram illustrating a mode in which a crop target region is changed by the crop section according to the preferred embodiment;

FIG. 12 is a diagram illustrating a detailed functional block configuration of the crop section in the mode in which the crop target region is changed in the preferred embodiment; and

FIG. 13 is a diagram illustrating a mode in which a trigger for changing the crop target region in the preferred embodiment is determined according to the posture of the head-mounted display.

### DETAILED DESCRIPTION OF THE PREFERRED EMBODIMENT

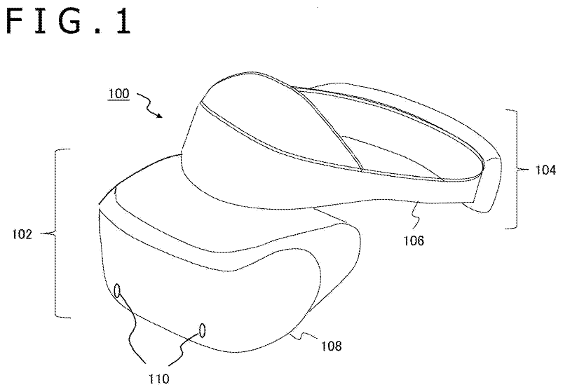

A preferred embodiment of the present disclosure relates to an image display system that displays an image on a head-mounted display worn on the head of a user. FIG. 1 illustrates an example of the appearance of a head-mounted display 100. In the example of FIG. 1, the head-mounted display 100 includes an output mechanism section 102 and a mounting mechanism section 104. The mounting mechanism section 104 includes a mounting band 106 that fastens the head-mounted display 100 to the whole circumference of the user's head when the user is wearing the head-mounted display 100.

The output mechanism section 102 includes a housing 108 and a display panel. The housing 108 is shaped in such a manner as to cover the left and right eyes of the user when the user is wearing the head-mounted display 100. The display panel is disposed inside the housing 108 and configured to face the eyes of the user when the user is wearing the head-mounted display 100. In the preferred embodiment, it is assumed that the display panel of the head-mounted display 100 is not transmissive. That is, a non-transmissive head-mounted display is used as the head-mounted display 100.

The housing 108 may further include an eyepiece that is positioned between the display panel and the eyes of the user to expand the viewing angle of the user when the user is wearing the head-mounted display 100. The head-mounted display 100 may additionally include speakers or earphones that are placed at positions corresponding to those of the ears of the user when the user is wearing the head-mounted display 100. Further, the head-mounted display 100 includes a built-in motion sensor to detect translational motions and rotational motions of the head of the user wearing the head-mounted display 100, and eventually detect the location and the posture of the user's head at each time point.

Moreover, the head-mounted display 100 includes a stereo camera 110. The stereo camera 110, which is mounted on the front surface of the housing 108, captures a moving image of the surrounding real space in the field of view corresponding to the gaze of the user. When the captured image is immediately displayed, what is generally called video see-through is achieved to enable the user to view the real space in the direction in which the user faces. Further, augmented reality (AR) is implemented when a virtual object is drawn on the image of a real object depicted in the captured image.

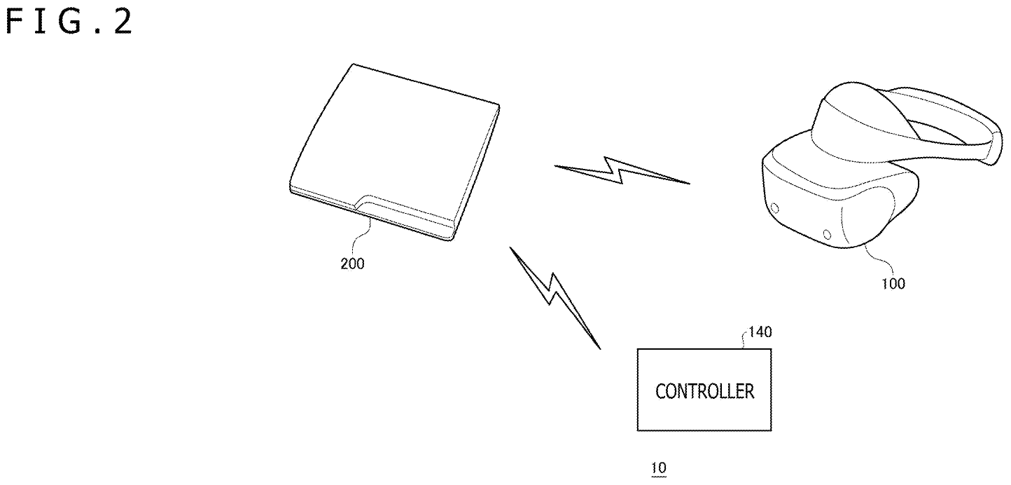

FIG. 2 is a diagram illustrating an example configuration of the image display system according to the preferred embodiment. The image display system 10 includes the head-mounted display 100, an image generation device 200, and a controller 140. The head-mounted display 100 is connected to the image generation device 200 through wireless communication. The image generation device 200 may be further connected to a server through a network. In such a case, the server may supply, to the image generation device 200, the data regarding an online application such as a game in which a plurality of users can participate through the network.

The image generation device 200 is an information processing device that determines the position of a user's viewpoint and the direction of a user's gaze according to the location and the posture of the head of the user wearing the head-mounted display 100, generates a display image in such a manner as to provide a corresponding field of view, and outputs the generated display image to the head-mounted display 100. For example, the image generation device 200 may generate the display image representing a virtual world serving as a stage of an electronic game while allowing the electronic game to progress, or display a moving image to provide a viewing experience or deliver information irrespective of whether the virtual world or the real world is depicted in the display image. Further, displaying, on the head-mounted display 100, a panoramic image in a wide angle of view centered on the user's viewpoint makes the user feel immersed in a displayed world. The image generation device 200 may be a stationary game console or a personal computer (PC).

The controller 140 is a controller (e.g., a game controller) that is gripped by a user's hand and used to input a user operation for controlling an image generation operation in the image generation device 200 and an image display operation in the head-mounted display 100. The controller 140 is connected to the image generation device 200 through wireless communication. As an alternative configuration, one of or both the head-mounted display 100 and the controller 140 may be connected to the image generation device 200 through wired communication via, for example, a signal cable.

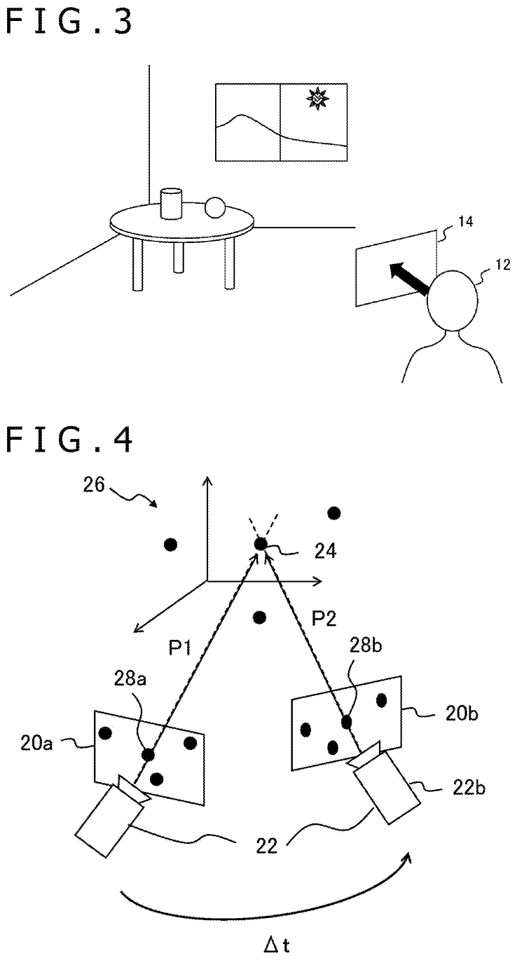

FIG. 3 is a diagram illustrating an example of an image world that is displayed on the head-mounted display 100 by the image generation device 200. The example of FIG. 3 creates a situation where a user 12 is in a room that is a virtual space. As depicted in FIG. 3, objects, such as walls, a floor, a window, a table, and things on the table, are disposed in a world coordinate system that defines the virtual space. For the world coordinate system, the image generation device 200 defines a view screen 14 based on the position of the viewpoint of the user 12 and the direction of the gaze of the user 12, and draws the display image by displaying the images of the objects on the view screen 14.

The image generation device 200 acquires the state of the head-mounted display 100 at a predetermined rate, and changes the position and the posture of the view screen 14 according to the acquired state. This enables the head-mounted display 100 to display an image in the field of view corresponding to the user's viewpoint. Further, when the image generation device 200 generates stereo images with parallax and displays the stereo images respectively in the left and right regions of the display panel of the head-mounted display 100, the user 12 is able to stereoscopically view the virtual space. This enables the user 12 to experience virtual reality that makes the user 12 feel like being in the room in the displayed world.

In order to achieve image representation depicted in FIG. 3, it may be required to track changes in the location and the posture of the user's head, thus track changes in the location and the posture of the head-mounted display 100, and then highly accurately control the position and the posture of the view screen 14 according to the tracked changes. Further, since the user 12 wearing the non-transmissive head-mounted display 100 is unable to view the surroundings in the real space, it may be necessary to provide a section to be used to avoid risks such as collision and stumbling. In the preferred embodiment, images captured by the stereo camera 110 are used to acquire necessary information regarding real objects with high efficiency and low latency.

An image used for display, such as video see-through display, is preferably captured in a wide angle of view adequate for covering the human field of view. The image captured in the above situation contains most of the information regarding the real objects surrounding the user and information regarding, for example, the location and the posture of the user's head with respect to the real objects. Accordingly, the preferred embodiment is configured to cut out a necessary portion of the captured image according to the intended purpose, use the cut-out portion for image analysis, and thus efficiently acquire necessary information without having to employ a separate dedicated sensor. In the following description, at least either the location or the posture of the head-mounted display 100 may be generically referred to as the “state” of the head-mounted display 100.

Visual SLAM is known as the technology of simultaneously estimating the location of a camera-mounted mobile body and creating an environmental map with use of captured images. FIG. 4 is a diagram outlining the principle of visual SLAM. A camera 22 is mounted on a mobile body to capture a moving image of the real space 26 within the field of view while changing the location and the posture of the camera 22. Let us now assume that feature points 28a and 28b indicating a point 24 on the same subject are respectively extracted from a frame 20a captured at a specific time point and a frame 20b captured with a time lag of Δt.

The position coordinate difference between the corresponding feature points 28a and 28b in individual frame planes (hereinafter may be referred to as the “corresponding points”) depends on the change in the location and the posture of the camera 22 which occurs with the time lag of Δt. More specifically, when the matrices representing the amounts of change caused by rotational motion and translational motion of the camera 22 are R and T, respectively, and the three-dimensional vectors between the camera 22 and the point 24 at the two different time points are P1 and P2, respectively, the following relational expression is established.

P1=RP·2+T

When the above relation is used to extract a plurality of corresponding points of two frames captured at different time points and solve a simultaneous equation, it is possible to determine the change in the location and the posture of the camera 22 that has occurred between the different time points. Further, when a process of minimizing the error in the result of derivation by recursive computation is performed, it is possible to accurately build three-dimensional information regarding a subject surface in the real space 26, such as the point 24. In a case where the stereo camera 110 is used as the camera 22, the three-dimensional position coordinates of, for example, the point 24 are determined on an individual time point basis. This makes it easier to perform computation, for example, for extracting the corresponding points.

However, even in a case where a monocular camera is used as the camera 22, the algorithm of visual SLAM is established. Consequently, when the intended purpose is to track the state of the head-mounted display 100, the camera to be included in the head-mounted display 100 is not limited to the stereo camera 110. Further, any one of a large number of algorithms proposed for visual SLAM may be adopted. In any case, according to the depicted principle, the change in the state of the camera 22 from a preceding time point is derived at the same rate as the frame rate of a moving image.

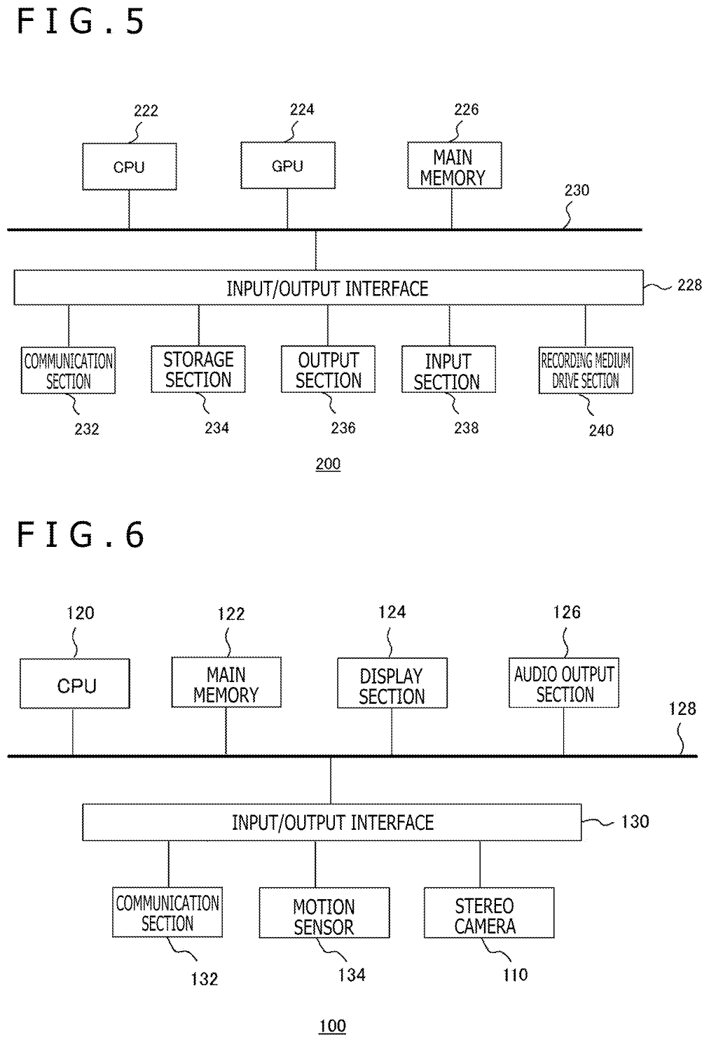

FIG. 5 illustrates an internal circuit configuration of the image generation device 200. The image generation device 200 includes a central processing unit (CPU) 222, a graphics processing unit (GPU) 224, and a main memory 226. These component elements are interconnected through a bus 230. The bus 230 is further connected to an input/output interface 228. The input/output interface 228 is connected to a communication section 232, a storage section 234, an output section 236, an input section 238, and a recording medium drive section 240.

The communication section 232 includes a universal serial bus (USB), Institute of Electrical and Electronics Engineers (IEEE) 1394, or other peripheral device interfaces, and a wired local area network (LAN), wireless LAN, or other network interfaces. The storage section 234 includes, for example, a hard disk drive or a non-volatile memory. The output section 236 outputs data to the head-mounted display 100. The input section 238 accepts data inputted from the head-mounted display 100, and accepts data inputted from the controller 140. The recording medium drive section 240 drives a removable recording medium such as a magnetic disk, an optical disk, or a semiconductor memory.

The CPU 222 provides overall control of the image generation device 200 by executing an operating system stored in the storage section 234. Further, the CPU 222 executes various programs (e.g., VR game applications) that are read from the storage section 234 or the removable recording medium and loaded into the main memory 226 or that are downloaded through the communication section 232. The GPU 224 functions as a geometry engine and as a rendering processor, performs a drawing process in accordance with a drawing instruction from the CPU 222, and outputs the result of drawing to the output section 236. The main memory 226 includes a random-access memory (RAM), and stores programs and data necessary for processing.

FIG. 6 illustrates an internal circuit configuration of the head-mounted display 100. The head-mounted display 100 includes a CPU 120, a main memory 122, a display section 124, and an audio output section 126. These component elements are interconnected through a bus 128. The bus 128 is further connected to an input/output interface 130. The input/output interface 130 is connected to a communication section 132, a motion sensor 134, and the stereo camera 110. The communication section 132 includes a wireless communication interface.

The CPU 120 processes information that is acquired from various sections of the head-mounted display 100 through the bus 128, and supplies a display image and audio data which are acquired from the image generation device 200, to the display section 124 and the audio output section 126. The main memory 122 stores programs and data that are necessary for processing in the CPU 120.

The display section 124 includes a display panel, such as a liquid-crystal panel or an organic electroluminescent (EL) panel, and displays an image in front of the eyes of the user wearing the head-mounted display 100. The display section 124 may achieve stereoscopic vision by displaying a pair of stereo images in regions corresponding to the left and right eyes. The display section 124 may further include a pair of lenses that are positioned between the display panel and the user's eyes when the user is wearing the head-mounted display 100 and that are configured to expand the viewing angle of the user.

The audio output section 126 includes speakers and earphones that are positioned to match the ears of the user when the user is wearing the head-mounted display 100 and that are configured to allow the user to hear a sound. The communication section 132 is an interface for transmitting and receiving data to and from the image generation device 200, and configured to establish communication based on a well-known wireless communication technology such as Bluetooth (registered trademark) technology. The motion sensor 134 includes a gyro sensor and an acceleration sensor, and acquires the angular velocity and acceleration of the head-mounted display 100.

As depicted in FIG. 1, the stereo camera 110 includes a pair of video cameras that capture, from left and right viewpoints, an image of the surrounding real space in the field of view corresponding to the user's viewpoint. Objects existing in the user's gaze direction (typically, in front of the user) are depicted in the frames of a moving image captured by the stereo camera 110. Values measured by the motion sensor 134 and captured image data acquired by the stereo camera 110 are transmitted as needed to the image generation device 200 through the communication section 132.

The image display system 10 according to the preferred embodiment sets a play area of the user according to information regarding the real space, which is acquired by using a captured image as mentioned earlier. The play area represents a real-world range where the user wearing the head-mounted display 100 is able to move while playing an application. In a case where, while playing the application, the user attempts to leave the play area or has left the play area, the image display system 10 presents a warning to the user in order to call a user's attention or prompt the user to return to the play area.

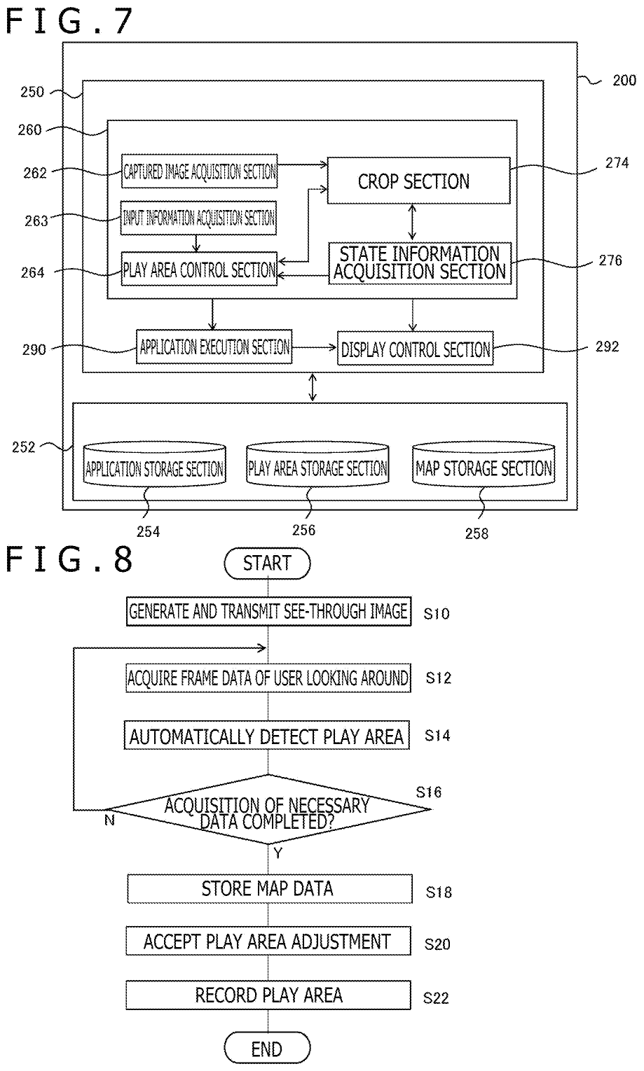

FIG. 7 is a block diagram illustrating functional blocks of the image generation device 200. As mentioned earlier, the image generation device 200 performs general information processes, for example, of allowing the electronic game to progress and communicating with the server. FIG. 7 particularly illustrates the details of the functional blocks involved in the processing of images captured by the stereo camera 110. Alternatively, at least some of the functions of the image generation device 200 which are depicted in FIG. 7 may be implemented in the head-mounted display 100 or in the server connected to the image generation device 200 through a network. Further, the function of cutting out (cropping) a frame of a captured image to acquire predetermined information, which is one of the functions of the image generation device 200, may be separately implemented as an information processing device.

Moreover, the plurality of functional blocks illustrated in FIG. 7 may be implemented by hardware including the CPU 222, the GPU 224, the main memory 226, and the storage section 234 depicted in FIG. 5 or may be implemented by software including a computer program having the functions of the plurality of functional blocks. Therefore, it will be understood by persons skilled in the art that the functional blocks may be variously implemented by hardware only, by software only, or by a combination of hardware and software. The method for implementing the functional blocks is not particularly limited to any one of them.

The image generation device 200 includes a data processing section 250 and a data storage section 252. The data processing section 250 performs various data processing tasks. The data processing section 250 transmits and receives data to and from the head-mounted display 100 and the controller 140 through the communication section 232, the output section 236, and the input section 238 depicted in FIG. 5. The data storage section 252 is implemented, for example, by the storage section 234 depicted in FIG. 5, and configured to store data that is referenced or updated by the data processing section 250.

The data storage section 252 includes an application storage section 254, a play area storage section 256, and a map storage section 258. The application storage section 254 stores, for example, programs and object model data that are necessary for executing a VR game or other applications that display an image. The play area storage section 256 stores data regarding the play area. The data regarding the play area includes data indicating the location of a point cloud that forms the boundary of the play area (e.g., coordinate values of individual points in the world coordinate system).

The map storage section 258 stores registration information for acquiring the location and the posture of the head-mounted display 100 and eventually the location and the posture of the head of the user wearing the head-mounted display 100. More specifically, the map storage section 258 stores data of a keyframe used for visual SLAM and data regarding the environmental map indicating the structure of an object surface in the three-dimensional real space (hereinafter referred to as the “map”) in association with each other.

The keyframe is a frame that is selected according to predetermined criteria from among the frames from which the feature points are extracted with visual SLAM. The predetermined criteria state, for example, the minimum number of feature points. In the preferred embodiment, however, the term “frame” may not always denote the whole region of a frame of a moving image captured by the stereo camera 110, and may occasionally denote a part of the region that is cropped out of the whole region in accordance with predetermined rules. When the keyframe is regarded as a “previous frame” and used for collation with the feature points of a current frame (the latest frame), it is possible to cancel errors that have been accumulated over time during the tracking of the location and the posture of the head-mounted display 100.

Map data includes information regarding the three-dimensional position coordinates of a point cloud representing the surface of an object existing in the real space where the user exists. Individual points are associated with the feature points extracted from the keyframe. Data of the keyframe is associated with the state of the stereo camera 110 at the time of keyframe data acquisition. The number of feature points to be included in the keyframe may be 24 or more. The feature points may include corners detected by a publicly-known corner detection method, and may be detected on the basis of the gradient of luminance.

The data processing section 250 includes a system section 260, an application execution section 290, and a display control section 292. The functions of the plurality of functional blocks mentioned above may be implemented in a computer program. The CPU 222 and the GPU 224 in the image generation device 200 may deliver the functions of the above-mentioned plurality of functional blocks by loading the above-mentioned computer program into the main memory 226 from the storage section 234 or a recording medium and executing the loaded computer program.

The system section 260 performs system processing regarding the head-mounted display 100. The system section 260 provides a common service to a plurality of applications (e.g., VR games) for the head-mounted display 100. The system section 260 includes a captured image acquisition section 262, an input information acquisition section 263, a crop section 274, a state information acquisition section 276, and a play area control section 264.

The captured image acquisition section 262 sequentially acquires pieces of frame data of an image captured by the stereo camera 110, which are transmitted from the head-mounted display 100. The acquired frame data is basically wide-angle image data that can be used for display. The input information acquisition section 263 acquires the description of a user operation through the controller 140. The crop section 274 operates such that a region necessary for processing to be performed at a subsequent stage is cropped out of a frame acquired by the captured image acquisition section 262.

The state information acquisition section 276 successively acquires the state information regarding the head-mounted display 100 by the above-mentioned visual SLAM method. More specifically, the state information acquisition section 276 acquires the information regarding the state of the head-mounted display 100, that is, the information regarding the location and the posture of the head-mounted display 100, at each time point according to, for example, the data of each cropped frame, which is supplied from the crop section 274, and the data stored in the map storage section 258. Alternatively, the state information acquisition section 276 may obtain the state information by integrating the information derived from image analysis with a value measured by the motion sensor 134 built in the head-mounted display 100.

The state information regarding the head-mounted display 100 is used, for example, to set the view screen for application execution, perform processing for monitoring the user's proximity to the play area boundary, and perform processing for warning against the user's proximity to the play area. Consequently, depending on the encountered situation, the state information acquisition section 276 provides the acquired state information as needed to the play area control section 264, the application execution section 290, and the display control section 292.

The play area control section 264 sets, as the play area, a real-space region where the user can move safely, and then presents a warning as needed when the user is in proximity to the boundary of the play area at a stage of application execution. When setting the play area, the play area control section 264 generates the map data by performing, for example, visual SLAM on the data of each cropped frame, which is supplied from the crop section 274.

The play area control section 264 also references the generated map data to automatically determine, as the play area, a floor surface region where no collision occurs, for example, with furniture or a wall. The play area control section 264 may cause the head-mounted display 100 to display an image depicting the determined boundary of the play area and may thus accept a user's editing operation on the play area. In this instance, the play area control section 264 acquires the description of a user operation which is performed from the controller 140, through the input information acquisition section 263, and changes the shape of the play area according to the acquired description of the user operation.

The play area control section 264 eventually stores the data regarding the determined play area in the play area storage section 256. The play area control section 264 also stores the generated map data and the keyframe data acquired together with the generated map data in the map storage section 258 in association with each other in order to allow the state information acquisition section 276 to read out the stored data subsequently at an appropriate timing.

An image cropped by the crop section 274 is not only used for acquiring the state information regarding the head-mounted display 100 and setting the play area, but may also be used for performing additional image analysis, such as image recognition, or used for generating the display image. Further, the functional blocks for making an image analysis by using a cropped image, such as some of the functional blocks of the state information acquisition section 276 and the play area control section 264, may be collectively referred to as an “image analysis section.”

The application execution section 290 reads out the data regarding a user-selected application, such as a VR game, from the application storage section 254, and then executes the read-out data. In this instance, the application execution section 290 successively acquires the state information regarding the head-mounted display 100 from the state information acquisition section 276, sets the position and the posture of the view screen according to the acquired state information, and draws a VR image. As a result, the virtual world of a display target is represented in the field of view corresponding to the movement of the user's head.

Further, depending on the user-selected application, the application execution section 290 may also generate an AR image. In this case, the application execution section 290 draws a virtual object by superimposing it on a frame of a captured image acquired by the captured image acquisition section 262 or on a frame cropped by the crop section 274 as appropriate for display processing. In this instance, the application execution section 290 determines the drawing position of the virtual object according to the state information acquired by the state information acquisition section 276. As a result, the virtual object is properly represented to match a subject depicted in the captured image.

The display control section 292 sequentially transmits the frame data of various images generated by the application execution section 290, such as a VR image and an AR image, to the head-mounted display 100. Further, when the play area is set, the display control section 292 transmits, as needed, to the head-mounted display 100, an image instructing the user to look around, an image depicting the state of a tentatively determined play area and accepting an editing operation, or an image warning against a user's proximity to the play area boundary, for example.

For example, when the play area is set, in accordance with a request from the play area control section 264, the display control section 292 transmits, to the head-mounted display 100, the data of a frame of a captured image acquired by the captured image acquisition section 262 or the data of a frame cropped by the crop section 274 as appropriate for display processing, and causes the head-mounted display 100 to display the transmitted data. As a result, video see-through is achieved to enable the user to view the real space in the direction in which the user faces. Accordingly, the safety of the user is increased. The opportunity for achieving video see-through is not limited to the above. Video see-through may be achieved in various situations, such as a period during which the user is away from the play area, before the start or after the end of an application, or a case where video see-through is requested by the user.

FIG. 8 is a flowchart illustrating a processing procedure for allowing the play area control section 264 to set the play area. The flowchart is based on the premise that communication is established between the image generation device 200 and the head-mounted display 100 and that the data of an image captured by the stereo camera 110 is transmitted from the head-mounted display 100. The processing depicted in the flowchart starts when the user selects play area initial setup or re-setup from a system setup menu of the head-mounted display 100.

The display control section 292 of the image generation device 200 generates a display image for video see-through by, for example, performing a necessary correction process on the data of a frame of a captured image, transmits the generated display image to the head-mounted display 100, and causes the head-mounted display 100 to display the generated display image (step S10). In this instance, the play area control section 264 causes the display control section 292 to superimpose and display, on the display image, a message prompting the user to look around. When the user faces in various directions in response to the displayed message and a captured image of the user is transmitted to the head-mounted display 100, the play area control section 264 sequentially acquires the data of frames of the captured image (step S12).

More specifically, first of all, the crop section 274 crops a region defined in accordance with predetermined rules out of the transmitted captured image, and the play area control section 264 sequentially acquires the cropped frame data. Next, the play area control section 264 automatically detects the play area according to the acquired frame data (step S14). More specifically, according to the frame data, the play area control section 264 estimates the three-dimensional shape of the space around the user by using a publicly-known method such as the visual SLAM method. When the visual SLAM method is used, the above processing corresponds to the generation of map data.

Subsequently, on the basis of the estimated three-dimensional shape, the play area control section 264 detects, as the floor surface, a plane perpendicular to the direction of gravity that is indicated by a value measured by the motion sensor 134. Further, the play area control section 264 constructs the three-dimensional shape, relative to the floor surface, of an object on the floor surface as an aggregate of points corresponding to the feature points extracted from a frame.

The play area control section 264 determines the boundary of the play area according to the aggregate of points, and generates play area data including the position coordinates of the boundary. At the time of play area detection, the play area control section 264 derives the height of the floor surface as the play area. For example, the distance in the direction of gravity between the floor surface and the head-mounted display 100 may be used as the height of the floor surface.

The play area control section 264 checks whether all pieces of three-dimensional space data necessary for play area setup is acquired. When such data acquisition is not completed (“N” in step S16), the play area control section 264 repeats steps S12 and S14 as needed for new frames. The necessary data is data required for completing play area setup. For example, the necessary data is the map data that covers the direction in which the user may possibly face and the direction in which the user is allowed to move. The play area control section 264 may perform step S16 by checking the distribution of the state of the stereo camera 110 in which the keyframe has been obtained.

Meanwhile, when acquisition of the necessary data is completed (“Y” in step S16), the play area control section 264 causes the map storage section 258 to store the map data and keyframe data acquired thus far (step S18). Next, the play area control section 264 accepts a user operation for play area adjustment (step S20). For example, the play area control section 264 generates a floor surface adjustment screen according to data indicating the height of the detected floor surface. The floor surface adjustment screen may include an AR image that is obtained by superimposing an object indicative of the floor surface (e.g., a translucent lattice-shaped object) on a captured image frame acquired by the captured image acquisition section 262.

The play area control section 264 causes the display control section 292 to display the floor surface adjustment screen on the display panel of the head-mounted display 100. The play area control section 264 accepts a user operation for floor surface height adjustment, which is inputted with respect to the floor surface adjustment screen, and changes the height of the floor surface according to the user operation. The play area control section 264 also generates a play area edit screen according to the data regarding the detected play area. The play area edit screen includes an AR image that is obtained by superimposing an object indicative of the play area on a captured image acquired by the captured image acquisition section 262.

The play area control section 264 causes the display panel of the head-mounted display 100 to display the play area edit screen. The play area control section 264 accepts a user's editing operation on the play area, which is inputted with respect to the play area edit screen, and changes the shape of the play area according to the user's editing operation. Next, the play area control section 264 stores the data regarding the eventually determined play area in the play area storage section 256 (step S22). The data regarding the play area includes, for example, the coordinate values of a point cloud representing a boundary surface.

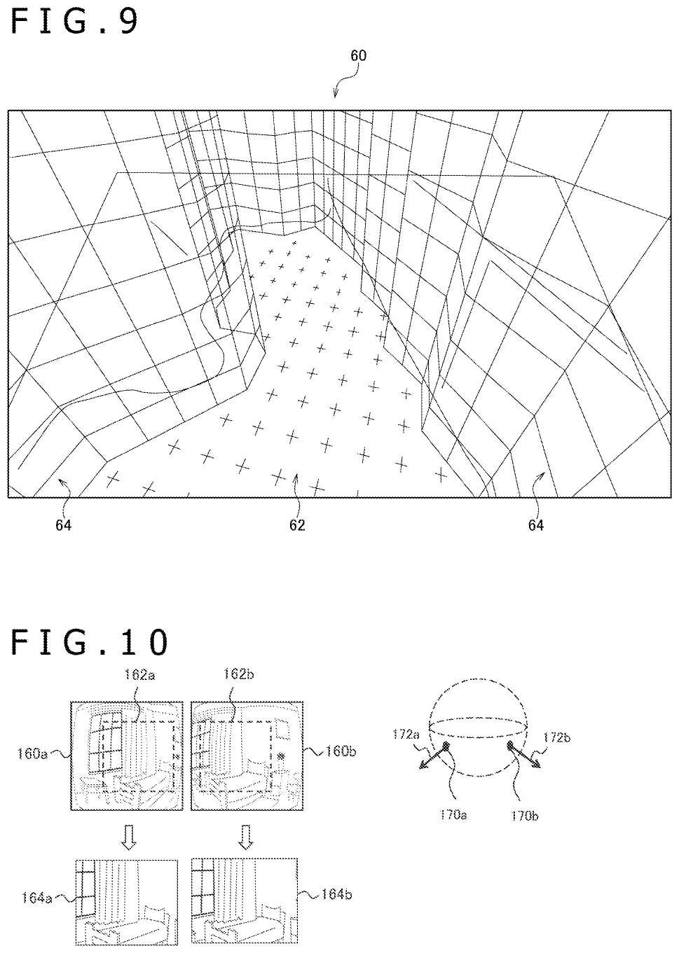

FIG. 9 illustrates an example of the play area edit screen that is displayed in step S20 of FIG. 8. A play area edit screen 60 includes a play area 62 and a boundary surface 64. The play area 62, which is an image depicting the play area (typically, a floor surface without obstacles), may be an image depicting, for example, a translucent lattice-shaped object. The boundary surface 64, which is an image depicting the boundary surface of the play area 62, is a plane perpendicular to the play area 62 at the boundary of the play area 62. The boundary surface 64 may also be, for example, a translucent lattice-shaped object. The play area edit screen may, in practice, display an image that is obtained by superimposing such an object as the depicted object on a video see-through image.

The play area control section 264 acquires, for example, through the controller 140, the description of a user operation performed with respect to the play area edit screen 60 to move the boundary surface 64 or expand or contract the play area 62. Eventually, when the user performs a confirmation operation, the play area control section 264 generates data indicating the resulting state of the play area 62 as the final state, and stores the generated data in the play area storage section 256.

In order to accurately determine the details of the play area in the depicted manner, it may be necessary to acquire, in step S12 of FIG. 8, frame data derived from various fields of view covering the real space around the user. That is, the higher the degree of space coverage by the frame data acquired in step S12, the higher the accuracy of the map data generated in step S18. This results in increasing the accuracy of the state information regarding the head-mounted display 100 that is acquired by the state information acquisition section 276 at the time of application execution. Consequently, the quality of VR image and other image representation can be improved.

Meanwhile, looking around until sufficient frame data is acquired may burden the user. In view of such circumstances, the crop section 274 in the preferred embodiment is configured such that the crop target region, which is used for map generation and play area detection, is changed appropriately in the plane of a captured image in order to efficiently obtain necessary frame data.

FIG. 10 is a diagram illustrating a basic process that is performed by the crop section 274. Images 160a and 160b schematically represent a pair of stereo image frames captured by the stereo camera 110, and depict the interior of a room where the user is in, as viewed from the left viewpoint and from the right viewpoint. The crop section 274 crops, for example, regions 162a and 162b out of the images 160a and 160b. The example of FIG. 10 assumes that, as depicted at right, optical axes 172a and 172b of two cameras 170a and 170b included in the stereo camera 110 are not aligned with a user's gaze directed toward the near side of FIG. 10.

More specifically, it is assumed that the optical axes 172a and 172b in the head-mounted display 100 are oriented outward in the horizontal direction to form an angle of 30° and are both oriented 35° downward from the horizontal plane. Meanwhile, in order to identify the position of a point on a subject surface by performing stereo matching through the use of visual SLAM, it is necessary to use stereo images with parallel optical axes.

Consequently, the crop section 274 crops inward regions out of the original images 160a and 160b in the depicted manner. More specifically, the crop section 274 crops the region 162a, which is displaced rightward from the center, out of the left viewpoint image 160a, and crops the region 162b, which is displaced leftward from the center, out of the right viewpoint image 160b. Further, in a case where a wide-angle camera with a fisheye lens is used as the stereo camera 110, the original images 160a and 160b are equidistant projection images. In this case, therefore, the crop section 274 converts the images of the cropped regions 162a and 162b to central projection images by using a well-known transformation matrix.

In the depicted example, however, the cropping position differs between the left and right images 160a and 160b. Therefore, the crop section 274 uses transformation matrices that respectively correspond to the left and right images 160a and 160b. Additionally, the crop section 274 may make a well-known image correction to accurately perform stereo matching. Performing the above-described processing generates central projection stereo images 164a and 164b with parallel optical axes.

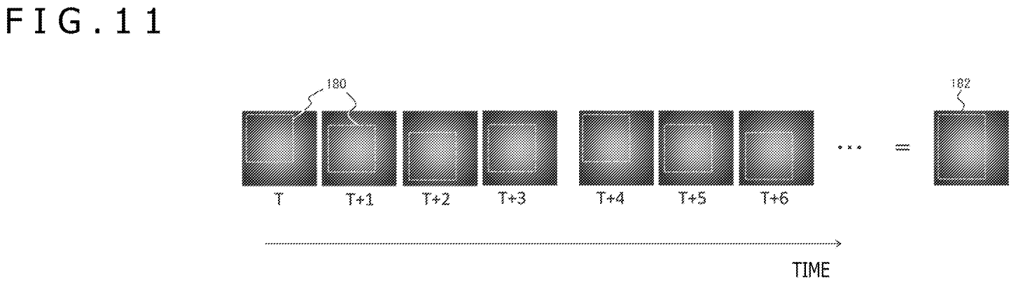

FIG. 11 is a diagram illustrating a mode in which the crop target region is changed by the crop section 274. The horizontal direction in FIG. 11 represents a time axis, and FIG. 11 depicts a row of right viewpoint image frames included in an image captured by the stereo camera 110. That is, frames T, T+1, T+2, and so on are sequentially captured and cropped in the order named. In the example of FIG. 11, as indicated by white dotted-line rectangles, the crop section 274 moves the crop target region (e.g., a region 180) in accordance with predetermined rules with respect to the time axis.

More specifically, the crop section 274 determines, as the crop target region of a frame, a region that has a predetermined size and is positioned in an upper, intermediate, or lower part in the frame plane. Then, the crop section 274 vertically reciprocates the crop target region within a row of chronologically arranged frames toward the upper part, the intermediate part, the lower part, the intermediate part, the upper part, the intermediate part, the lower part, and so on. The depicted row of frames T, T+1, T+2, and so on may include all the frames captured by the stereo camera 110 or may include frames remaining after being decimated in accordance with predetermined rules, for example, at intervals of one frame or two frames.

In any case, a change in the user's face orientation and eventually a change in the field of view of the row of frames are limited during a minute period of time equivalent to several to several dozen frame intervals. When the crop target region is rapidly changed with respect to the above-described row of frames, objects within different ranges are highly likely to be depicted in each region. As a result, even when the region from which the feature points are extracted is limited in each frame, information regarding a region 182 covering a wide range is obtained as depicted at the right end of FIG. 11. Further, when the user's face orientation changes over a longer span, information covering the surrounding space can be obtained efficiently in a short period of time.

In the above instance, the crop target region is limited to three types, namely, upper, intermediate, and lower types in the frame plane. Therefore, when parameters used for image correction are calculated in advance and associated with individual regions, calculation during operation can be simplified to quickly correct a cropped image. The number of types of crop target regions is not limited to three. Two types or four or more types of regions may be cropped as long as their positions and sizes are predetermined. However, the number of corresponding points representing common points on a subject increases with an increase in the overlapping area of crop target regions of the preceding and succeeding frames. This results in increasing the accuracy of map generation.

Further, the crop section 274 need not always move the crop target region at a constant speed. Alternatively, the crop section 274 may change the movement speed of the crop target region, depending on their positions in the frame plane. For example, the crop section 274 may decrease the movement speed in a predetermined region, such as a region near the center of the frame plane, and may eventually increase the number of crops in the predetermined region. Alternatively, the range of crop target region change may be narrowed in the predetermined region. As described later, the crop section 274 may identify, on each occasion, a region where a floor or another specific object is highly likely to be depicted, and decrease the speed of crop target region movement in the identified region.

FIG. 11 depicts only the row of right viewpoint frames. However, the crop section 274 naturally performs cropping with respect to the row of left viewpoint frames as well while changing the corresponding region, that is, the region at the same vertical position. The horizontal positional relation between the crop target regions in the left and right viewpoint frames is dependent on the relation between the optical axes of the stereo camera 110, as described with reference to FIG. 10.

Consequently, as long as constraints imposed by the above-mentioned relation between the optical axes do not bind, the crop section 274 may horizontally move the regions to be cropped. That is, the crop section 274 may move the crop target region in any direction in the frame plane. For example, the crop section 274 may reciprocate the crop target regions in a horizontal direction in the frame plane or reciprocate the crop target regions in a diagonal direction in the frame plane. Alternatively, the crop section 274 may move the crop target regions in the order of raster scan in the frame plane.

An image derived from cropping by the crop section 274 is not always used for map generation and play area detection. More specifically, the image derived from cropping may be used for allowing the state information acquisition section 276 to acquire the state information regarding the head-mounted display 100 or used for allowing the play area control section 264 to detect the floor surface in the play area, as described above. The crop section 274 may change the crop target regions in accordance with rules that vary with the usage of the image.

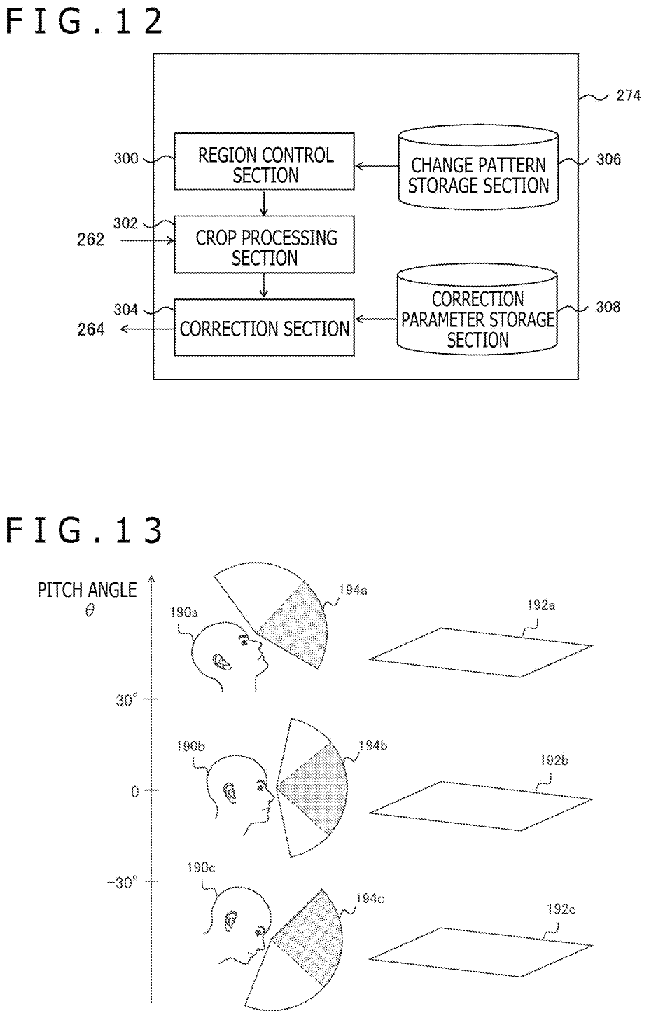

FIG. 12 illustrates a detailed functional block configuration of the crop section 274 in the mode in which the crop target region is changed. The crop section 274 includes a region control section 300, a crop processing section 302, a correction section 304, a change pattern storage section 306, and a correction parameter storage section 308. The change pattern storage section 306 stores, in association with the usage of a cropped image, setup information regarding the rules for changing the crop target region.

In a case where the intended purpose is to generate the map or detect the play area, an image covering the space can efficiently be acquired by moving the crop target region thoroughly as depicted in FIG. 11. Meanwhile, in a case where the intended purpose is to collect images including specific object images, for example, for floor surface detection, the crop section 274 may identify, on the basis of the state of the head-mounted display 100 at the time of imaging, a region where a desired image is highly likely to be depicted, and perform changeover as needed to crop the identified region. Alternatively, the crop target region movement under the rules with respect to the time axis may be performed in combination with the changeover based on the state of the head-mounted display 100.

In any case, information required for changeover, such as conditions prescribing the size, movement speed, and movement route of a crop target region and the trigger for changing the crop target region, is stored beforehand in the change pattern storage section 306. The region control section 300 accesses the change pattern storage section 306 to read out crop target region change rules on the basis of the usage of an image, and determines the crop target region of each frame in accordance with the read-out crop target region change rules. The usage of the image is specified by an image requester such as the play area control section 264 or the state information acquisition section 276.

Under the control of the region control section 300, the crop processing section 302 crops the crop target region out of each of the stereo images acquired from the captured image acquisition section 262. The correction parameter storage section 308 stores parameters necessary for image correction of a cropped region in association with position information regarding the cropped region. In a case where cropping is performed at three different positions, namely, upper, intermediate, and low positions, as depicted in FIG. 11, the correction parameter storage section 308 stores, in advance, the correction parameters calculated for individual regions, in association with the individual regions.

In a case where the positions of the crop target regions in the left and right viewpoint images vary in the horizontal direction as depicted in FIG. 11, the correction parameter storage section 308 stores two types of correction parameters for left and right viewpoints in association with each of the three crop target regions, namely, the upper, intermediate, and lower regions. Even in a case where the crop target regions differ in number and position, the correction parameter storage section 308 similarly stores the correction parameters in association with each of the crop target regions.

The correction section 304 accesses the correction parameter storage section 308 to read out the corresponding correction parameters for the regions cropped by the crop processing section 302, and corrects the images of the cropped regions according to the read-out correction parameters. This generates data of partial stereo images like the stereo images 164a and 164b depicted in FIG. 10. The correction section 304 sequentially supplies the generated data to the image requester such as the play area control section 264.

In a case where the cropped images are to be used for map generation, images from which many feature points are derived as mentioned earlier are stored as the keyframes, and subsequently used for acquiring the state information regarding the head-mounted display 100. Therefore, the map storage section 258 needs to store the state information regarding the head-mounted display 100 obtained at the time of keyframe imaging, in association with each keyframe. However, the state of the head-mounted display 100 at the time of capture of an uncropped image does not always coincide with a virtual state of the head-mounted display 100 in a case where a cropped image is to be tentatively captured.

For example, in a case where an upper part of the frame plane is cropped, the optical axes of the stereo camera 110 naturally move upward at the time of capture of a cropped image. As a result, the state of the head-mounted display 100 also changes according to the movement of the optical axes. Consequently, the correction section 304 converts the state of the head-mounted display 100 at the time of capture of the uncropped image to the virtual state of the head-mounted display 100 in a situation where the cropped image is to be captured.

Subsequently, the correction section 304 supplies the state information regarding the converted state to the play area control section 264 in association with the data of the cropped image. It is sufficient if the play area control section 264 selects a keyframe by performing the same processing as the regular one and stores the selected keyframe and the corresponding state information in the map storage section 258. The parameters used for converting the state information regarding the head-mounted display 100 are dependent on the position of a crop target region, and are therefore stored in the correction parameter storage section 308 together with image correction parameters.

FIG. 13 is a diagram illustrating a mode in which the trigger for changing the crop target region is determined according to the posture of the head-mounted display 100. When setting the play area, the play area control section 264 first detects the surface of a floor, and then detects the surfaces of surrounding objects with reference to the detected floor surface. Therefore, collecting captured images depicting the floor surface with respect to various states of the head-mounted display 100 improves the efficiency of a play area setup process.

Owing to the characteristics of the floor, which is fixed, a region where the floor is depicted within a captured image is approximately identified with respect to the posture of the head-mounted display 100 (stereo camera 110) and eventually the posture of the user's head. In FIG. 13, a pitch angle θ of the user's gaze direction is represented by the vertical axis, and the vertical field of view of the stereo camera 110 in three different states is depicted in a fan shape. In a state where a ceiling is in the field of view, for example, of a user 190a, a floor 192a is highly likely to be depicted in a lower part of the captured image.

In a state where the user faces forward like a user 190b, a floor 192b is highly likely to be depicted in an intermediate part of the captured image. In a state where, like a user 190c, the user faces downward and the user's body is in the user's field of view, a floor 192c is highly likely to be depicted in an upper part of the captured image. Therefore, the crop section 274 sets a threshold value for the pitch angle indicating the posture of the head-mounted display 100, and changes the crop target region according to the pitch angle of the head-mounted display 100 at the time of capture of a processing target frame. In the mode illustrated in FIG. 13, the crop section 274 successively acquires, from the head-mounted display 100, values measured by the motion sensor 134, and identifies the posture of the head-mounted display 100.

In the example of FIG. 13, a threshold value of ±30° is set for the pitch angle θ, and the crop target region is changed on the basis of three different angles of view, which are each represented by a shaded portion of the fan shape indicating the field of view. More specifically, when 30°≤θ, a predetermined region 194a including the lower end of the captured image is cropped. When −30°≤θ<30°, a predetermined region 194b including a central part of the captured image is cropped. When θ<−30°, a predetermined region 194c including the upper end of the captured image is cropped. The change rules described above enable the play area control section 264 to efficiently collect floor images and detect the floor surface in the play area within a short period of time.

In the example of FIG. 13, the crop target region is defined on the assumption that the stereo camera 110 is disposed as depicted in FIG. 10 in such a manner that the optical axes are oriented slightly downward in the head-mounted display 100. More specifically, the crop target region is defined on the basis of characteristics that increase the possibility of the user's body being depicted in the captured image while the user faces downward like the user 190c and increase the possibility of the floor being depicted in the center of the captured image while the user faces forward like the user 190b. As described above, the threshold value to be applied to the pitch angle θ and the crop target region in each state are defined by additionally considering the way of mounting the stereo camera 110 in the head-mounted display 100. Further, there is no limitation on the number of states classified according to the threshold value.

Moreover, the crop target region in each state may be changed according to the user's posture, such as a standing posture or a seated posture. The crop section 274 may identify the user's posture on the basis of, for example, the description of a currently executed application and an estimated height of the floor surface detected at such an application execution stage, and determine the crop target region according to the identified user's posture.

With reference to the example of FIG. 13, when the pitch angle θ of the head-mounted display 100 fluctuates in the vicinity of either +30° or −30°, the crop target region might frequently change to cause latency, for example, in correction processing. Accordingly, the crop section 274 may prevent such chattering by varying the threshold value according to the direction of change in the pitch angle θ, that is, depending on whether the change in the pitch angle θ is in the direction of increasing or decreasing.

The example of FIG. 13 assumes that images of a floor are to be collected. However, when the position of the image of a target, which is fixed in the real space, within a captured image can approximately be identified with respect to the posture of the head-mounted display 100, image collection may be achieved by a method similar to that applied to the floor. Consequently, objects targeted for image collection and the description of information processing performed with use of collected images are not specifically limited to any details. Further, the crop target region may be determined in consideration of the posture of the head-mounted display 100 on the premise that, as depicted in FIG. 11, the crop target region is moved with respect to the time axis in accordance with predetermined rules.

For example, instead of changing the crop target region at a constant speed as depicted in FIG. 11, the crop section 274 may increase the number of crops in a region where a specific target is highly likely to be depicted and decrease the number of crops in the other regions. That is, the crop section 274 may increase or decrease the movement speed according to the position of a region in an image plane and eventually weight the number of crops. The amount of weight may be changed according to the posture of the head-mounted display 100.

According to the preferred embodiment described above, an image captured by the stereo camera included in the head-mounted display is not only used for display purposes, such as video see-through display and AR display, but also used for image analysis. In such an instance, an optimal region is cropped and used in accordance with rules that are defined on the basis of analysis results and intended purposes. As a result, analysis can be made without sacrificing efficiency even when the angle of view of the stereo camera is expanded.

Further, the crop target region is varied from one frame to another in accordance with predetermined rules. For example, several crop target regions are prepared to periodically change from one crop target region to another. As a result, even when the scope of a region used for a single analysis is small, a wide field of view can be analyzed by information accumulation in the time direction. Consequently, the information regarding the real objects which covers the space around the user can efficiently be acquired to reduce the burden on the user engaged in map generation and play area detection.

Moreover, several different states depending on the posture of the head-mounted display are prepared to change the crop target region according to the actual posture. As a result, images of a floor and other objects important for analysis can efficiently be collected. When image correction parameters corresponding to the crop target region are prepared in advance, the image derived from cropping can be corrected in a short period of time and passed to a subsequent process. This makes it possible to rapidly change the crop target region and acquire necessary information in a shorter period of time.

The above-described configuration eliminates the necessity of using a dedicated sensor for acquiring various types of information. Therefore, high-quality image representation is provided even when the adopted head-mounted display has a simple configuration. At the same time, the above-described configuration avoids degrading the feeling of wearing the head-mounted display due to an increase in weight and power consumption.

The present disclosure has been described above in terms of the preferred embodiment. It will be understood by persons skilled in the art that the above-described preferred embodiment is illustrative and not restrictive, and that the combination of component elements and processes described in conjunction with the preferred embodiment may be variously modified without departing from the spirit and scope of the present disclosure.

What is claimed is:

1. An information processing device comprising:
a captured image acquisition section that acquires data of frames of a currently captured moving image;
a crop section that cuts out an image of a specific region from each of the frames arranged in chronological order; and
an image analysis section that analyzes the image of the specific region to acquire predetermined information,
wherein the crop section moves a cut-out target region in accordance with predetermined rules with respect to a time axis.

2. The information processing device according to claim 1, wherein the crop section reciprocates the cut-out target region in a predetermined direction in a frame plane.

3. The information processing device according to claim 1, further comprising:
an image correction parameter storage section that stores parameters for image correction of each of a plurality of regions set as the cut-out target region,
wherein the crop section changes the cut-out target region between the plurality of regions, and corrects a cut-out image according to the corresponding parameters.

4. The information processing device according to claim 1, wherein the crop section moves the cut-out target region at a constant speed in a predetermined direction in a frame plane.

5. The information processing device according to claim 1, wherein the crop section changes the cut-out target region at intervals of one frame or a predetermined number of frames, and cuts out an image after each change.

6. The information processing device according to claim 1, wherein the crop section changes a movement speed of the cut-out target region in a frame plane according to a position of the cut-out target region in the frame plane.

7. The information processing device according to claim 6, wherein the crop section identifies a region where a predetermined object is highly likely to be depicted in the frames, and decreases the movement speed of the cut-out target region in the identified region.

8. The information processing device according to claim 7,
wherein the captured image acquisition section acquires data of the frames captured by a camera mounted on a head-mounted display, and,
on a basis of a posture of the head-mounted display, the crop section identifies a region where the predetermined object is highly likely to be depicted.

9. The information processing device according to claim 1,
wherein the captured image acquisition section acquires data of the frames captured by a camera mounted on a head-mounted display, and
the image analysis section acquires information regarding a configuration of objects existing around a user wearing the head-mounted display.

10. An information processing method comprising:
acquiring data of frames of a currently captured moving image;
cutting out an image of a specific region from each of the frames arranged in chronological order; and
analyzing the image of the specific region to acquire predetermined information,
wherein the cutting out moves a cut-out target region in accordance with predetermined rules with respect to a time axis.

11. A computer program for a computer, comprising:
by a captured image acquisition section, acquiring data of frames of a currently captured moving image;
by a crop section, cutting out an image of a specific region from each of the frames arranged in chronological order; and
by an image analysis section, analyzing the image of the specific region to acquire predetermined information,
wherein the cutting out moves a cut-out target region in accordance with predetermined rules with respect to a time axis.
